(19) United States
(12) Patent Application Publication
(10) Pub. No.: US 2012/0224161 A1
(43) Pub. Date: Sep. 6, 2012

(54) Lithographic Apparatus and Method

(75) Inventors: Ruud Antonius Catharina Maria BEERENS, Roggel (NL); Antonius Franciscus Johannes De Groot, Someren (NL)

(73) Assignee: ASML Netherlands B.V., Veldhoven (NL)

(21) Appl. No.: 13/361,390

(22) Filed: Jan. 30, 2012

Related U.S. Application Data
(60) Provisional application No. 61/448,409, filed on Mar. 2, 2011.

(51) Int. Cl. G03B 27/54

(52) U.S. Cl. 355/67

(57) ABSTRACT

A lithographic apparatus comprising an illumination system for providing a beam of radiation, a support structure for supporting a patterning device, the patterning device serving to impart the radiation beam with a pattern in its cross-section, a substrate table for holding a substrate, and a projection system for projecting the patterned radiation beam onto a target portion of the substrate, wherein the projection system includes a moveable lens connected to an actuator which is configured to move the moveable lens during projection of the patterned radiation beam onto the target portion of the substrate.

### CROSS REFERENCE TO RELATED APPLICATIONS

This application claims the benefit under 35 U.S.C. §119(e) to U.S. Provisional Patent Application No. 61/448,409, filed Mar. 2, 2011, which is incorporated by reference herein in its entirety.

### BACKGROUND

1. Field of Invention

The present invention relates to a lithographic apparatus and a device manufacturing method.

2. Related Art

A lithographic apparatus is a machine that applies a desired pattern onto a target portion of a substrate. Lithographic apparatus can be used, for example, in the manufacture of integrated circuits (ICs). A patterning device, which is alternatively referred to as a mask, may be used to generate a circuit pattern corresponding to an individual layer of the IC, and this pattern can be imaged onto a target portion (e.g., comprising part of, one or several dies) on a substrate (e.g., a silicon wafer) that has a layer of radiation-sensitive material (resist). In general, a single substrate will contain a network of adjacent target portions that are successively exposed. Known lithographic apparatus include scanners, in which each target portion is irradiated by scanning the pattern device through the beam in a given direction (the “scanning” direction) while synchronously scanning the substrate parallel or anti-parallel to this direction.

Following exposure of a target portion by the lithographic apparatus the substrate is displaced in a direction transverse to the scanning direction. The direction of travel of the patterning device is reversed and the direction of travel of the substrate is reversed. A new target portion on the substrate is then exposed. The time required to move the substrate in the transverse direction and to reverse the directions of travel of the patterning device and the substrate may be considerable.

### SUMMARY

According to an aspect of the present invention, there is provided a lithographic apparatus comprising an illumination system for providing a beam of radiation, a support structure for supporting a patterning device, the patterning device serving to impart the radiation beam with a pattern in its cross-section, a substrate table for holding a substrate, and a projection system for projecting the patterned radiation beam onto a target portion of the substrate, wherein the projection system includes a moveable lens connected to an actuator which is configured to move the moveable lens during projection of the patterned radiation beam onto the target portion of the substrate.

The actuator may be configured to move the moveable lens such that the patterned radiation beam moves in a scanning direction of the lithographic apparatus.

The movement of the patterned radiation beam may compensate for a difference between a scanning speed of the substrate and an effective scanning speed of the patterning device.

The actuator may be configured to move the moveable lens in a scanning direction of the lithographic apparatus.

The actuator may be configured to rotate the moveable lens. The moveable lens may have a point of rotation which is at or near to the patterning device.

The lithographic apparatus, wherein a controller of the lithographic apparatus is configured to control the support structure and the substrate table such that either or both of them is accelerating or decelerating during projection of the pattern onto the substrate.

The lithographic apparatus may further comprise a second support structure for supporting a second patterning device.

The moveable lens may be one of a plurality of moveable lenses which are configured to be consecutively brought into intersection with the patterned radiation beam.

According to another aspect of the present invention there is provided a method comprising providing a beam of radiation using an illumination system, using a patterning device to impart the radiation beam with a pattern in its cross-section, the patterning device moving in a scanning direction, and projecting the patterned radiation beam onto a target portion of the substrate, the substrate moving in a scanning direction, wherein the method further comprises moving a moveable lens during projection of the patterned radiation beam onto the target portion of the substrate such that the patterned radiation beam is moved.

The patterned radiation beam may be moved in a scanning direction.

The movement of the patterned radiation beam may compensate for a difference between a scanning speed of the substrate and an effective scanning speed of the patterning device.

The moveable lens may move in a scanning direction of the lithographic apparatus.

The moveable lens may rotate.

The patterning device and/or the substrate may be accelerating or decelerating during projection of the pattern onto the substrate.

The patterning device and/or the substrate may be accelerating or decelerating during projection of up to 90% of the pattern onto the substrate.

The patterning device and/or the substrate may undergo acceleration and deceleration which has a substantially sinusoidal form.

A second patterning device may be subsequently used to impart the radiation beam with a pattern in its cross-section, the second patterning device moving in a scanning direction, wherein the second patterning device has an effective speed which is greater than the speed of the substrate, and wherein movement of the moveable lens compensates for the greater effective speed of the second patterning device.

The second patterning device may be provided with a pattern which is different from the pattern on the first patterning device.

The moveable lens may compensate for errors in the position of the patterning device and/or substrate.

Further features and advantages of the present invention, as well as the structure and operation of various embodiments of the present invention, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the present invention and to enable a person skilled in the relevant art(s) to make and use the present invention.

FIG. 1 depicts a lithographic apparatus according to an embodiment of the present invention.

FIG. 2 depicts part of a projection system of a lithographic apparatus according to an embodiment of the present invention.

FIG. 3 depicts the part of the projection system of FIG. 2 with a lens 11 in an alternative position.

FIG. 4 depicts part of a projection system of a lithographic apparatus according to an embodiment of the present invention.

FIGS. 5a, 5b, 5c, 5d, and 5e depict a device manufacturing method according to an embodiment of the present invention.

Features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This patent document describes one or more embodiments of the invention that incorporate various features of the invention. The disclosed embodiment(s) merely exemplify the present invention. The scope of the present invention is not limited to the disclosed embodiment(s). The present invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including Ultraviolet (UV) radiation (e.g., having a wavelength of 365, 248, 193, 157 or 126 nm) and extreme ultra-violet (EUV) radiation (e.g., having a wavelength in the range of 5-20 nm).

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “mask” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g., water, so as to fill a space between the final element of the projection system and the substrate. Immersion techniques are well known in the art for increasing the numerical aperture of projection systems.

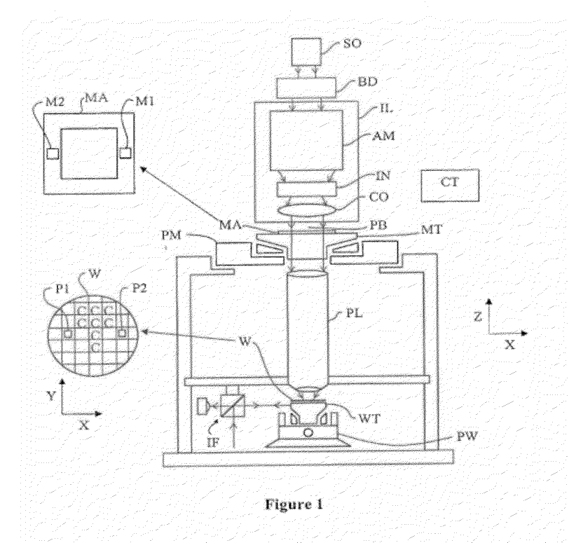

FIG. 1 schematically depicts a lithographic apparatus according to a particular embodiment of the present invention. The apparatus comprises an illumination system IL to condition a beam PB of radiation (e.g., DUV radiation or EUV radiation), a support structure (e.g., a mask table) MT to support a patterning device (e.g., a mask) MA and connected to first positioning device PM to accurately position the patterning device with respect to item PL, a substrate table (e.g., a wafer table) WT for holding a substrate (e.g., a resist coated wafer) W and connected to second positioning device PW for accurately positioning the substrate with respect to item PL, and a projection system (e.g., a refractive projection lens) PL configured to image a pattern imparted to the radiation beam PB by patterning device MA onto a target portion C (e.g., comprising one or more dies) of the substrate W.

As here depicted, the apparatus is of a transmissive type (e.g., employing a transmissive mask). Alternatively, the apparatus may be of a reflective type (e.g., employing a programmable mirror array of a type as referred to above).

The illumination system IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illumination system IL with the aid of a beam delivery system BD comprising for example suitable directing mirrors and/or a beam expander. In other cases the source may be an integral part of the apparatus, for example when the source is a mercury lamp. The source SO and the illumination system IL, together with the beam delivery system BD if required, may be referred to as a radiation system.

The illumination system IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illumination system can be adjusted. In addition, the illumination system IL generally comprises various other components, such as an integrator IN and a condenser CO. The illumination system provides a conditioned beam of radiation PB, having a desired uniformity and intensity distribution in its cross section.

The radiation beam PB is incident on the patterning device (e.g., mask) MA, which is held on the support structure MT. Having traversed the patterning device MA, the beam PB passes through the lens PL, which focuses the beam onto a target portion C of the substrate W. With the aid of the second positioning device PW and position sensor IF (e.g., an interferometric device), the substrate table WT can be moved accurately, e.g., so as to position different target portions C in the path of the beam PB. Similarly, the first positioning device PM and another position sensor (which is not explicitly depicted in FIG. 1) can be used to accurately position the patterning device MA with respect to the path of the beam PB, e.g., after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in a scanning mode, wherein the support structure MT and the substrate table WT are scanned synchronously while a pattern imparted to the beam PB is projected onto a target portion C (i.e., a single dynamic exposure). The velocity and direction of the substrate table WT relative to the support structure MT is determined by the (de-)magnification and image reversal characteristics of the projection system PL. The maximum size of the exposure field limits the width (in the non-scanning direction) of the target portion in a single dynamic exposure, whereas the length of the scanning motion determines the height (in the scanning direction) of the target portion.

In a conventional lithographic apparatus a mask support structure and a substrate table are controlled such that they both have constant speeds during projection of a radiation beam onto a substrate. Conventionally, the projection system of a lithographic apparatus has a reduction factor of 4, and the speed of movement of the substrate table is therefore one quarter of the speed of movement of the support structure. Operating the lithographic apparatus in this manner ensures that the speed at which the substrate is moving is matched to the speed at which the pattern projected from the mask is moving. As a result, the pattern is accurately exposed on the substrate. If the pattern projected from the mask were to travel at a different speed to substrate then the exposed pattern would be stretched or compressed in the scanning-direction. If the mismatch between the speeds were sufficiently large then damage to the exposed pattern (i.e., stretching or compression) might prevent correct functioning of an integrated circuit or other device formed using the pattern. It is in order to avoid this eventuality that conventional lithographic apparatus only expose substrates when the mask and the substrate are moving at desired constant speeds.

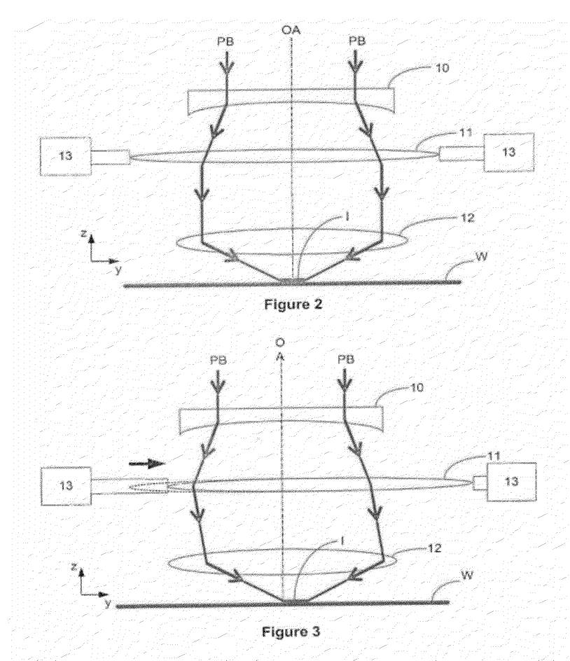

FIG. 2 shows schematically in cross-section part of a projection system of a lithographic apparatus according to an embodiment of the present invention. FIG. 2 shows the last three lenses 10, 11 and 12 of the projection system which together comprise an image position adjustment apparatus. The image position adjustment apparatus may comprise a different number of lenses (or other optics including for example reflective optics). FIG. 2 also shows a substrate W located beneath the lenses. An optical axis OA of the projection system is indicated by a dotted line. Arrows schematically indicate a radiation beam PB which travels through the image position adjustment apparatus including lenses 10, 11 and 12 and forming an image I on the substrate W. The image I is an image of part of a mask MA (see FIG. 1) bearing a pattern which is being projected onto the substrate. During a scanning exposure the mask MA moves through the radiation beam such that the pattern in the image I moves in a scanning motion through the image. The substrate W moves at the same speed as the pattern, thereby facilitating accurate projection of the pattern from the mask MA onto the substrate.

Cartesian coordinates are indicated in FIG. 2 (and other figures) in order to facilitate explanation of the present invention. According to the standard convention, the scanning direction is the y-direction (or −y-direction), and the optical axis OA extends in the z-direction.

The middle lens 11 of the image position adjustment apparatus including lenses 10, 11 and 12 is connected to actuators 13 which are configured to move the lens in the scanning direction of the lithographic apparatus. Although two actuators 13 are shown in FIG. 2 any number of actuators may be used to move the middle lens 11. The middle lens 11 is hereafter referred to as the movable lens 11. The upper lens 10 of the three lenses 10, 11 and 12 has a planar upper surface and a concave lower surface, and is configured to apply divergence to the radiation beam PB. The moveable lens 11 collimates the radiation beam PB. The lower lens 12 is convex, and focuses the radiation beam PB to form the image I on the substrate W. Embodiments of the present invention may comprise more or less lenses than are shown in FIG. 2. The lenses may be provided in a different order and/or may have a different form.

FIG. 3 shows the same apparatus as FIG. 2. However, in FIG. 3 the moveable lens 11 has been moved by the actuators 13 in the y-direction. The position of the moveable lens 11 before it was moved by the actuators 13 is indicated by a dotted line in FIG. 3, and the movement of the lens is indicated by an arrow. As may be seen by comparing FIGS. 2 and 3, moving the moveable lens 11 in the y-direction modifies the manner in which radiation beam PB travels to the substrate W, and as a result the image I formed on the substrate W is shifted in the y-direction.

Movement of the moveable lens 11 in the y-direction may be used to compensate for a difference between the scanning speed of the substrate W and the effective scanning speed of a mask MA (see FIG. 1) from which a pattern is being projected onto the substrate. In this context the effective scanning speed of the mask MA may be considered to be the scanning speed of the mask divided by the reduction factor of the lithographic apparatus (e.g., a reduction factor of 4). The compensation provided by the moveable lens 11 may be such that the pattern being projected onto the substrate in the image moves at the same speed as the substrate W and is therefore accurately projected onto the substrate.

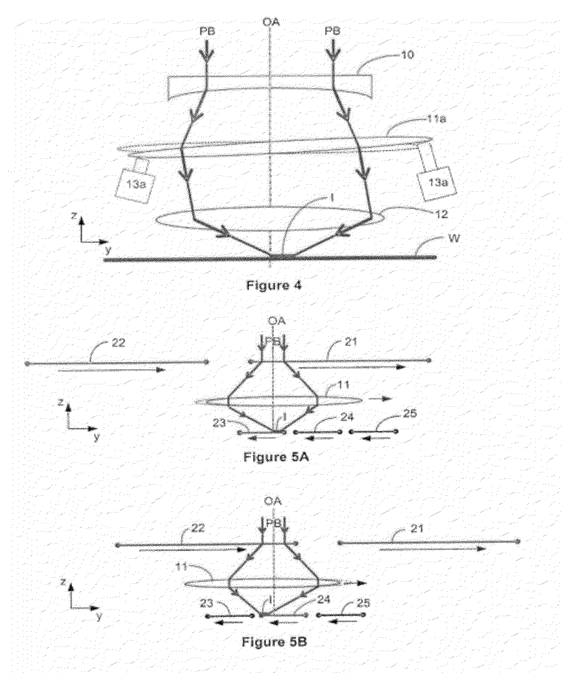

An alternative embodiment of the present invention is shown schematically in cross-section in FIG. 4. The alternative embodiment of the present invention is an image position adjustment apparatus which again comprises three lenses 10, 11a, 12 (although other numbers of lenses or other optics may be used). In common with FIGS. 2 and 3, a substrate W is shown in FIG. 4 together with arrows representing the passage of a radiation beam PB through the lenses. The optical axis OA is also indicated in FIG. 4. The embodiment shown in FIG. 4 corresponds with the embodiment shown in FIG. 3, except that instead of moving the moveable lens 11 in the y-direction, actuators 13a are configured to rotate the orientation of the moveable lens 11a. The moveable lens 11a is shown in a rotated position in FIG. 4, with a non-rotated position of the moveable lens being indicated by a dotted line. The axis of rotation about which the moveable lens 11a rotates may for example be at a mask or near to a mask used to pattern the radiation beam PB (the mask is not shown in FIG. 4). As may be seen from FIG. 4, the rotation of the moveable lens 11a causes an image I formed by the radiation beam on the substrate W to be moved in the y-direction. Rotation of the lens 11a may be used to compensate for a difference between the scanning speed of the substrate W and an effective scanning speed of a mask used to pattern the radiation. The reference to the point of rotation of the moveable lens 11a being near to the mask may be interpreted as meaning that the point of rotation is sufficiently close to the mask to avoid focussing errors arising from rotation of the moveable lens which cause an unacceptable deterioration of the accuracy with which the pattern is projected onto the substrate.

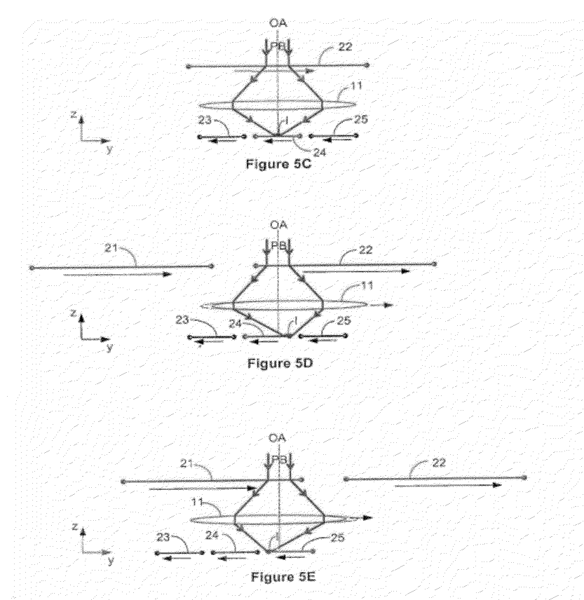

FIGS. 5a, 5b, 5c, 5d, and 5e illustrate schematically as a series of steps one way in which an embodiment of the present invention may be used to increase the throughput of a lithographic apparatus (throughput being the number of substrates which are patterned per hour by the lithographic apparatus). FIGS. 5a, 5b, 5c, 5d, and 5e show schematically in cross-section first and second masks 21, 22, moveable lens 11 and three substrate dies 23, 24 and 25. The first and second masks 21, 22 may both be provided with the same pattern or may be provided with different patterns. The lenses 10, 12 shown in FIGS. 2-4 are omitted from FIG. 5, as is the rest of the projection system PL, in order to avoid over-complication of the figure. Similarly, although the dies 23, 24 and 25 are on a substrate which is held on a substrate table, both the substrate and the substrate table are omitted for clarity. References to movement of the masks may be interpreted as referring to movement of the mask support structure, and references to movement of the dies may be interpreted as referring to movement of the substrate and substrate table.

The reduction factor of the lithographic apparatus is represented schematically in FIGS. 5a, 5b, 5c, 5d, and 5e, with the masks 21, 22 being approximately four times bigger than the dies 23, 24 and 25. The movement in the y-direction of the masks 21, 22 is indicated by arrows pointing in the y-direction, and the movement of the dies 23, 24 and 25 is indicated by arrows extending in the −y-direction. The respective sizes of the arrows schematically indicate the speeds at which the masks 21, 22 and dies 23, 24 and 25. The speed of the masks 21, 22 is not four times the speed of the dies 23, 24 and 25, as would be expected in a conventional lithographic apparatus, but instead is greater than this. The reason for the increased speed of the masks 21, 22 is explained below.

It is desirable to produce as many dies as possible from a lithographic substrate (e.g., a wafer), and for this reason the distance between adjacent dies may be small. The distance between dies may for example be sufficient to allow the substrate to be cut up into individual dies without damaging the dies. In a lithographic apparatus in which two masks 21, 22 are provided (e.g., as shown in FIG. 5) the separation between the masks may be greater than four times the separation between adjacent dies on the substrate. This may be for example in order to accommodate mechanical features of the support structure (not shown in FIG. 5) which supports the masks 21, 22. Because the separation between the masks 21, 22 is more than four times greater than the separation between the dies 23-25, it is not possible to expose the first and second dies 23, 24 by moving the substrate at a constant velocity in the −y-direction whilst at the same time moving the masks 21, 22 at a constant velocity in the y-direction. If this were to be attempted then unpatterned radiation would be incident upon the second die 24 because the second die 24 would reach the radiation beam PB before the second mask 22.

An embodiment of the present invention overcomes the above problem by accelerating the masks 21, 22 to a higher speed such that the time between the first mask 21 leaving intersection with the radiation beam and the second mask 22 entering intersection with the radiation beam PB is equal to the time for the first die 23 to leave intersection with the radiation beam and the second die 24 to enter intersection with the radiation beam. Because the masks 21, 22 have been accelerated to a higher speed, when a final portion of the pattern of the first mask 21 is being projected onto the first die 23, the first mask will be travelling at a speed which is more than four times greater than the speed of the first die 23. The effective speed of the mask 21 (i.e., taking into account the reduction factor of the lithographic apparatus) is thus greater than the speed of the first die 23. This means that in the absence of movement of the moveable lens 11 the pattern projected from the first mask 21 would move faster than the first die 23, and would not be projected accurately onto the first die (the pattern would be compressed).

The movement of the moveable lens 11 in the y-direction compensates for the increased speed of the first mask 21 by moving the image I such that the speed at which the projected pattern moves at the first die is equal to the speed of movement of the first die. As a result, a pattern on the first mask 21 is accurately projected onto the first die 23. The speed of movement of the image I provided by the moveable lens 11 is equivalent to the increase of the speed of movement of the first mask 21 (taking into account the reduction factor of the lithographic apparatus). Thus, the speed of movement of the image plus the speed of movement of the first die 23 is equal to the speed of movement of the first mask (taking into account the reduction factor of the lithographic apparatus). As a result of the movement of the moveable lens 11, the moveable lens is offset in y-direction relative to the optical axis OA.

The first mask 21 and the first die 23 will move out of intersection with the radiation beam PB due to their respective movement in the y-direction and the −y-direction. During the period when neither the first mask 21 nor the first die 23 intersect with the radiation beam PB, the moveable lens 11 is moved in the −y-direction such that it is offset in the −y-direction relative to the optical axis OA. This is the position of the moveable lens 11 that is shown in FIG. 5B. The movement of the moveable lens 11 in the −y-direction may have an acceleration and deceleration trajectory which is sufficiently high to allow the moveable lens to be moved to the offset −y-direction position before the second mask 22 and second die 24 intersect with the radiation beam PB.

The increased speed of the first and second masks 21, 22 is such that the second mask will enter the radiation beam PB at the same time that the second die 24 enters the radiation beam (i.e., the increased speed compensates for the larger separation between the first and second masks 21, 22). Because the moveable lens 11 has been offset in the −y-direction relative to the optical axis OA, the image I is also offset in the −y-direction relative to the optical axis. During exposure of the first part of the second die 24 the effective speed of the second mask 22 is greater than the speed of the second die 24. This difference in speed is compensated for by movement of the moveable lens 11 in the y-direction. The movement of the moveable lens 11 in the y-direction compensates for the increased speed of the second mask 22 by moving the image I such that the speed at which the projected pattern moves at the second die 24 is equal to the speed of movement of the second die 24. As a result, a pattern or the second mask 22 is accurately projected onto the second die 24.

After the second mask 22 has passed into the radiation beam PB, the speed of the second mask may be reduced until the second mask has an effective speed which corresponds with the speed of the second die 24. When the second mask 22 is decelerating to this speed, the moveable lens 11 may be decelerating by an equivalent amount (taking into account the reduction factor of the lithographic apparatus). As a result, the speed at which the projected pattern moves at the second die 24 remains equal to the speed at which the second die is moving during the deceleration of the second mask 22. The speed of movement of the second die 24 itself remains constant.

When the speed of the second mask 22 has been reduced such that its effective speed is equal to the speed of the second die 24, the moveable lens 11 is brought to rest. This may be when the moveable lens is centrally positioned relative to the optical axis OA (as shown in FIG. 5C). The moveable lens 11 may remain at rest whilst the second mask 22 is moving with an effective speed which corresponds to the speed of movement of the second die 24.

Referring to FIG. 5D, as the final portion of the second mask 22 is reached, the second mask is accelerated in order to allow the second mask to be removed from the radiation beam PB and to allow the first mask 21 to enter the radiation beam during a period of time which corresponds to the time taken for the second die 24 to leave the radiation beam and the third die 25 to enter the radiation beam. As described further above, the moveable lens 11 moves in the y-direction in order to compensate for the increased speed of the second mask 22.

In FIG. 5E the first mask 21 is again in intersection with the radiation beam, and the third die 25 receives radiation patterned by the radiation beam. The effective speed of the first mask 21 is greater than the speed of the third die 25, and the moveable lens 11 moves in the y-direction in order to compensate for this difference in speed. Exposure of the third die 25 continues in the manner described above in relation to the second die 24.

The lithographic apparatus schematically illustrated in FIG. 5 may include two support structures (instead of the single support structure MT shown in FIG. 1). The support structures may include one or more actuators (not illustrated) configured to move the masks 21, 22 in the x-direction and then move them in the −y-direction and subsequently in the −x-direction so that they may be presented to the radiation beam PB in succession. This allows the first and second masks 21, 22 to be continuously introduced into the radiation beam PB.

As illustrated by FIG. 5, embodiments of the present invention increase the throughput of the lithographic apparatus because they allow a substrate to move with a constant speed during lithographic projection, instead of for example requiring the substrate to decelerate between each exposure in order to allow time for a new mask to be introduced into the radiation beam.

In the method shown in FIG. 5 the moveable lens 11 is stationary when a pattern is being projected from a middle portion of the second mask 22 onto the second die 24. Acceleration of the second mask 22 and compensatory movement of the moveable lens 11 only occurs for edge portions of the second mask (in order to allow the gap between the first and second masks to be bridged sufficiently quickly). However, in alternative embodiments the moveable lens 11 may move during projection of an entire pattern from a mask onto a die (or during projection of more than half of the pattern, or during projection of more than three quarters of the pattern).

Although the method shown in FIG. 5 uses the moveable lens 11 to allow the speed of movement of the masks 21, 22 to be increased in order to accommodate a large separation between the masks, the moveable lens may be used in other ways. The moveable lens 11 allows projection of a pattern onto a substrate to occur when the effective speed of a mask (taking into account the reduction factor of the lithographic apparatus) is different from the effective speed of the substrate. This allows projection of a pattern to occur for example when the mask and the substrate are moving at constant speeds with the effective speed of the mask being faster or slower than the speed of the substrate. It also allows projection of a pattern to occur when the mask and/or the substrate are being accelerated or decelerated. Theoretically it might be possible to accelerate (or decelerate) the mask and the substrate at the same rate (taking into account the reduction factor), in which case projection of a pattern could take place without using the moveable lens 11. However, this may be difficult or impossible to achieve in practice, and there is likely to be a difference between the rate of acceleration (or deceleration) of the mask and substrate. This difference may be accommodated by using the moveable lens 11.

In an embodiment, the moveable lens 11 may be used in a lithographic apparatus which uses a single mask rather than a pair of masks. In a conventional lithographic apparatus exposure of adjacent dies on a substrate is requires the direction of scanning movement of both the mask and the substrate to be reversed (in addition to a displacement of the substrate in the x-direction). Projection of a pattern onto the substrate is not initiated until the mask and the substrate are both moving at constant velocities. In an embodiment, the moveable lens 11 may be used to compensate for differences in (effective) speed between the mask and the substrate during their acceleration, thereby allowing projection of a pattern onto the substrate to be initiated whilst the mask and the substrate are accelerating. Similarly, the moveable lens 11 may be used to compensate for differences in (effective) speed between the mask and the substrate during their deceleration, thereby allowing projection of the pattern onto the substrate to continue whilst the mask and the substrate are decelerating.

The moveable lens 11 provides a degree of flexibility to the speed of movement of the mask and the substrate that is not present in the prior art. For example, in the above described single mask embodiment the mask and/or the substrate may have velocities which vary with a sinusoidal profile (or some other profile). In the prior art the speeds of the mask and the substrate are increased as quickly as possible to a desired projection speed and are then held at that speed before being decreased as quickly as possible. The prior art thus applies rapid and discontinuous accelerations and decelerations to the mask and substrate table, which may cause undesirable vibrations to occur in the lithographic apparatus. By allowing the mask and substrate to be moved with a sinusoidal profile (or some other profile), rapid and discontinuous accelerations and decelerations of the mask and substrate may be avoided, thereby reducing undesirable vibrations in the lithographic apparatus. The movement of the mask and/or substrate may be less jerky than in a conventional lithographic apparatus.

Referring to FIG. 5, in an embodiment the first and second masks may be moved with a constant speed through the radiation beam, and the speed of the dies 23-25 may be adjusted to compensate for the larger distance between adjacent masks. This may be achieved by reducing the speed of the dies during the projection of a pattern onto edge portion of a die and using the moveable lens 11 to compensate for the reduced speed of the dies.

Embodiments of the present invention may be used to obtain ‘double patterning’ of the substrate in an efficient manner. Double patterning refers to projecting a first pattern onto a die and then projecting a second pattern onto a die, the first and second patterns complementing each other to form a combined pattern. Referring again to FIG. 5, the first mask 21 may be provided with a first pattern and the second mask 22 may be provided with a second pattern, the first and second patterns being arranged such that when they are both projected onto a die they form a combined pattern. A row of dies on the substrate (e.g., all of the dies on the substrate W have a given x-direction position) may be exposed using the method illustrated in FIG. 5. As a result some of the dies will receive the first pattern and some of the dies will receive the second pattern. The scanning direction of movement of the substrate and the masks 21, 22 is then reversed and the row of dies is exposed for a second time. The masks 21, 22 are arranged such that the first die of the row is exposed with the pattern that it has not already received. Since the first and second masks 21, 22 are used alternately, subsequent dies are automatically exposed with the pattern that they have not already received. Consequently, the each die of the row of dies is exposed with the pattern from the first mask 21 and the pattern from the second mask 22, and double patterning of the dies is thereby achieved.

Although the method shown in FIG. 5 uses two masks, the method may use three or more masks.

The moveable lens 11, 11a may move during projection of an entire pattern onto a die. Alternatively, it may move during projection of up to 90% of a pattern onto a die, up to 60% of a pattern onto a die, or up to 30% of a pattern onto a die. The moveable lens 11, 11a may move during projection of a pattern onto edge portions of a die. The edge portions of the die may for example be up to 10% of the die, up to 20% of the die, up to 30% of the die or more.

Above described embodiments are primarily directed towards using the moveable lens 11, 11a to compensate for an increase of the speed of the mask or substrate above a conventional speed. However, embodiments of the present invention may also be used to compensate for a decrease of the speed of the mask or substrate below a conventional speed.

In an embodiment, the moveable lens 11, 11a may be used to compensate for errors in the position of the mask and/or substrate. For example, errors arising in the positioning of the mask may be measured and compensated for in real time by moving the moveable lens 11, 11a to move the image projected onto the substrate. Similarly, errors arising in the positioning of the substrate may be measured and compensated for in real time by moving the moveable lens 11, 11a to move the image projected onto the substrate.

Embodiments of the present invention move the image I during projection of a pattern from the mask onto the substrate. The image I may be referred to as an exposure slit.

For ease of understanding the above description has referred to projecting radiation from a mask onto a die. It may be case however that the mask is provided with a pattern which comprises two or more dies, or is provided with a pattern which is part of a die. Embodiments of the present invention encompass these possibilities. Hence, references to a die may be interpreted as referring to a target portion.

For ease of understanding the above description has referred to moving a mask or masks. As will be appreciated for example by referring to FIG. 1, the mask or masks may be supported by one or more support structures. Thus, references to moving a mask may be interpreted as referring to moving a mask support structure.

For ease of understanding the above description has referred to moving dies or a substrate. As will be appreciated for example by referring to FIG. 1, the dies (or target portions) will form part of a substrate which is supported by a substrate table. Thus, references to moving a die or a substrate may be interpreted as referring to moving a substrate table.

In the illustrated embodiments of the present invention the moveable lens 11 moves in the y-direction during exposure of a die. However, the moveable lens 11 may move in the −y-direction during exposure of other dies (the scanning direction of the substrate W being reversed). The moveable lens may be the to move the radiation beam PB in the scanning direction. The scanning direction, in the context of the figures, may be considered to be the y-direction or the −y-direction.

In the illustrated embodiments a single moveable lens 11, 11a is used to move the image projected onto the substrate. As explained further above in relation to FIG. 5, the position of the moveable lens 11 is reset when masks 21, 22 are not intersecting with the radiation beam PB. In an embodiment, instead of resetting the position of the moveable lens 11, a plurality of moveable lenses are provided. Referring to FIG. 5A, when exposure of the first die 23 has been completed the moveable lens 11 may be moved out of intersection with the radiation beam PB by continuing to move the lens in the y-direction. A new moveable lens (not shown) may then be moved into intersection with the radiation beam PB by moving the new moveable lens in y-direction from a position which is displaced in the −y-direction from the optical axis OA. In this embodiment the moveable lens shown in FIG. 5B is the new moveable lens. In an embodiment, a plurality of moveable lenses may be provided. The number of moveable lenses may be equal to or greater than the number of dies to be exposed in a row on a substrate (or may be some other number). The plurality of moveable lenses may be provided on a support structure, for example arranged in a row or provided on a disk.

In FIGS. 5a, 5b, 5c, 5d, and 5e the direction of movement of the masks is opposite to the direction of movement of the dies. However, in an embodiment the masks and the dies may be moved in the same direction (this may also apply to other embodiments). Moving the masks and the dies in opposite directions may be preferred in order to reduce movement of the centre of gravity of the lithographic apparatus and thereby provide the lithographic apparatus with better stability.

The scanning speed of the substrate table WT and the scanning speed of the patterning device support structure MA may be controlled by a controller CT (see FIG. 1). The controller may for example comprise a processor or other electronics. The controller may form part of the lithographic apparatus.

Any use of the terms “mask” or “mask” herein may be considered synonymous with the more general term “patterning device”.

While specific embodiments of the present invention have been described above, it will be appreciated that the present invention may be practiced otherwise than as described. The description is not intended to limit the present invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1-15. (canceled)

16. A lithographic apparatus comprising:
an illumination system for providing a beam of radiation;
a support structure for supporting a patterning device, the patterning device being configured and arranged to impart the radiation beam with a pattern in its cross-section;
a substrate table for holding a substrate; and
a projection system for projecting the patterned radiation beam onto a target portion of the substrate; wherein the projection system includes a moveable lens connected to an actuator which is configured to move the moveable lens during projection of the patterned radiation beam onto the target portion of the substrate.

17. The lithographic apparatus of claim 16, wherein the actuator is configured to move the moveable lens such that the patterned radiation beam moves in a scanning direction of the lithographic apparatus.

18. The lithographic apparatus of claim 17, wherein the movement of the patterned radiation beam compensates for a difference between a scanning speed of the substrate and an effective scanning speed of the patterning device.

19. The lithographic apparatus of claim 16, wherein the actuator is configured to move the moveable lens in a scanning direction of the lithographic apparatus.

20. The lithographic apparatus of any of claims 16, wherein the actuator is configured to rotate the moveable lens.

21. The lithographic apparatus of claim 1, wherein a controller of the lithographic apparatus is configured to control the support structure and the substrate table such that either or both of them is accelerating or decelerating during projection of the pattern onto the substrate.

22. The lithographic apparatus of claim 1, wherein the lithographic apparatus further comprises a second support structure for supporting a second patterning device.

23. A method comprising:
providing a beam of radiation using an illumination system;
using a patterning device to impart the radiation beam with a pattern in its cross-section, the patterning device moving in a scanning direction; and
projecting the patterned radiation beam onto a target portion of the substrate, the substrate moving in a scanning direction; and
moving a moveable lens during projection of the patterned radiation beam onto the target portion of the substrate such that the patterned radiation beam is moved.

24. The method of claim 23, wherein the patterned radiation beam is moved in a scanning direction.

25. The method of claim 24, wherein the movement of the patterned radiation beam compensates for a difference between a scanning speed of the substrate and an effective scanning speed of the patterning device.

26. The method of any of claims 23, wherein the patterning device and/or the substrate is accelerating or decelerating during projection of the pattern onto the substrate.

27. The method of any of claims 23, further comprising using a second patterning device to impart the radiation beam with a pattern in its cross-section, the second patterning device moving in a scanning direction, wherein the second patterning device has an effective speed which is greater than the speed of the substrate, and wherein movement of the moveable lens compensates for the greater effective speed of the second patterning device.

28. The method of claim 27, wherein the second patterning device is provided with a pattern which is different from the pattern on the first patterning device.

29. The method of claim 23, wherein the moveable lens compensates for errors in the position of the patterning device and/or substrate.

30. A device manufactured according to claim 23.
